(19) United States
(12) Patent Application Publication
(10) Pub. No.: US 2014/0113143 A1
(43) Pub. Date: Apr. 24, 2014

(54) TRANSPARENT CONDUCTIVE FILMS

(71) Applicant: Carestream Health, Inc., Rochester, NY (US)

(72) Inventors: William D. Devine, III, Fort Collins, CO (US); Eric J. Adsit, Fort Collins, CO (US); Margaret P. Evans, Fort Collins, CO (US)

(21) Appl. No.: 14/052,889

(22) Filed: Oct. 14, 2013

Related U.S. Application Data
(60) Provisional application No. 61/715,335, filed on Oct. 18, 2012.

(51) Int. Cl. H01B 1/12

(52) U.S. Cl. CPC H01B 1/124
USPC 428/419; 428/522; 428/448; 428/426; 428/519

(57) ABSTRACT

Conductive films containing substrates, primer layers, and conductive layers are disclosed and claimed. Such conductive films can exhibit superior total light transmission, in some cases greater than that of the substrates themselves. These conductive films are useful in electronics applications.

### CROSS REFERENCE TO RELATED APPLICATIONS

This application claims the benefit of U.S. Provisional Patent Application No. 61/715,335, filed Oct. 18, 2012, entitled TRANSPARENT CONDUCTIVE FILMS, which is hereby incorporated by reference in its entirety.

### SUMMARY

A first embodiment provides a transparent conductive film comprising a transparent substrate comprising a first surface and a second surface, the first surface and second surface disposed on opposite sides of the transparent substrate; at least one first primer layer disposed on the first surface of the transparent substrate, the at least one first primer layer comprising at least one first subbing resin and at least one first adhesion promoter; and at least one first conductive polymer layer disposed on the at least one first primer layer, the at least one first conductive polymer layer comprising at least one first conductive polymer. In at least some embodiments, the at least one first subbing resin comprises from about 35 wt % to about 96 wt % of vinylidene chloride, from about 3.5 wt % to about 64.5 wt % of an ethylenically unsaturated ester, and from about 0.5 wt % to about 25 wt % of at least one of itaconic acid, the half methyl ester of itaconic acid, acrylic acid, or methacrylic acid. In other cases, the at least one first subbing resin comprises a terpolymer of vinylidene chloride, acrylonitrile, and acrylic acid.

In at least some embodiments, the at least one first adhesion promoter comprises resorcinol. In at least some embodiments, the at least one first primer layer further comprises at least one first solid material comprising at least one of amorphous silica, glass, quartz, diatomaceous earth, or calcium carbonate. In some cases, the at least one first primer layer further comprises at least one first solid material comprising amorphous silica.

In at least some embodiments, the at least one first conductive polymer comprises poly(3,4-ethylenedioxythiophene) doped with poly(styrenesulfonate).

In any of the above embodiments, there may optionally be provided at least one second primer layer disposed on the second surface of the transparent substrate, the at least one second primer layer comprising at least one second subbing resin and at least one second adhesion promoter.

In such embodiments, there may optionally be provided at least one second conductive polymer layer disposed on the at least one second primer layer, the at least one second conductive polymer layer comprising at least one second conductive polymer. In at least some cases, the at least one second conductive polymer comprises poly(3,4-ethylenedioxythiophene) doped with poly(styrenesulfonate).

In any of the above embodiments, the transparent conductive film may exhibit total light transmittance greater than that of the transparent substrate itself. Such films are useful in electronics applications.

These embodiments and other variations and modifications may be better understood from the description, exemplary embodiments, examples, and claims that follow. Any embodiments provided are given only by way of illustrative examples. Other desirable objectives and advantages inherently achieved may occur or become apparent to those skilled in the art.

### DESCRIPTION

All publications, patents, and patent documents referred to in this document are incorporated by reference herein in their entirety, as though individually incorporated by reference.

U.S. Provisional Patent Application No. 61/715,335, filed Oct. 18, 2012, entitled TRANSPARENT CONDUCTIVE FILMS, is hereby incorporated by reference in its entirety.

At least some embodiments provide transparent conductive films (TCFs) comprising at least one transparent substrate comprising a first surface and a second surface; at least one first primer layer disposed on the first surface; and at least one first conductive polymer layer disposed on the at least one first primer layer. In at least one embodiments, at least one second primer layer may be disposed on the at least one second surface. In some cases, at least one second conductive polymer layer may be disposed on the at least one second primer layer.

### Transparent Substrates

At least some embodiments provide TCFs comprising at least one transparent substrate. The substrate may be rigid or flexible. Suitable rigid substrates include, for example, rigid glasses, polycarbonates, acrylics, and the like. When coating mixes for the various layers of the TCF are coated onto a flexible substrate, the substrate is preferably a flexible, transparent polymeric film that has any desired thickness and is composed of one or more polymeric materials. The substrate is required to exhibit dimensional stability during coating and drying of the conductive layer and to have suitable adhesive properties with overlying layers. Useful polymeric materials for making such substrate include polyesters (such as polyethylene terephthalate and polyethylene naphthalate), cellulose acetate and other cellulose esters, polyvinyl acetal, polyolefins, polycarbonates, polystyrenes, and flexible glasses. Preferred substrates are composed of polymers having good heat stability, such as polyesters and polycarbonates. Support materials may also be treated or annealed to reduce shrinkage and promote dimensional stability. Transparent multilayer substrates can also be used.

At least some embodiments provide transparent conductive films comprising transparent substrates that comprise at least one polyester. The at least one polyester may, for example, comprise at least about 70 wt % ethylene terephthalate repeat units. Or it may comprise at least about 75 wt %, or at least about 80 wt %, or at least about 85 wt %, or at least about 90 wt % or at least about 95 wt % ethylene terephthalate repeat units.

Such polyesters may, for example, be made through condensation polymerization of one or more monomers comprising acid or ester moieties with one or more monomers comprising alcohol moieties. Non-limiting examples of monomers comprising acid or ester moieties include, for example, aromatic acids or esters, aliphatic acids or esters, and non-aromatic cyclic acids or esters. Exemplary monomers comprising acid or ester moieties include, for example, terephthalic acid, dimethyl terephthalate, isophthalic acid, dimethyl isophthalate, phthalic acid, methyl phthalate, trimellitic acid, trimethyl trimellitate, naphthalene dicarboxylic acid, dimethyl naphthalate, adipic acid, dimethyl adipate, azelaic acid, dimethyl azelate, sebacic acid, dimethyl sebacate, and the like. Exemplary monomers comprising alcohol moieties include, for example, ethylene glycol, propanediol, butanediol, hexanediol, neopentyl glycol, diethylene glycol, cyclohexanedimethanol, and the like.

Such polyesters may, for example, comprise repeat units comprising a first residue from a monomer comprising acid or ester moieties joined by an ester linkage to a second residue from a monomer comprising alcohol moieties. Exemplary repeat units are, for example, ethylene terephthalate, ethylene isophthalate, ethylene naphthalate, diethylene terephthalate, diethylene isophthalate, diethylene naphthalate, cyclohexylene terephthalate, cyclohexylene isophthalate, cyclohexylene naphthalate, and the like. Such polyesters may comprise more than one type of repeat group and may sometimes be referred to as copolyesters.

### Primer Layers

At least some embodiments provide one or more primer layers disposed one or both surfaces of the at least one transparent substrate. When primer layers are disposed on both surfaces, they may comprise the same composition or differing compositions, or the same thickness or differing thicknesses. Primer layers may, for example, have thicknesses from about 0.05 to about 1 μm, or from about 0.075 to about 0.5 μm, or from about 0.1 to about 0.2 μm, or about 0.15 μm.

In some embodiments, the at least one first primer layer, or the at least one second primer layer, or both, may comprise one or more subbing resins. A suitable resin for this purpose is a terpolymer comprising from about 35 wt % to about 96 wt % of vinylidene chloride, from about 3.5 wt % to about 64.5 wt % of an ethylenically unsaturated ester (also referred to as an acrylic ester), and from about 0.5 wt % to about 25 wt % of itaconic acid or the half methyl ester of itaconic acid, acrylic acid, or methacrylic acid. The ethylenically unsaturated esters can be acrylonitrile, methacrylonitrile, vinyl chloride, and alkyl esters of acrylic and methacrylic acids having 1 to 18 carbon atoms in the alkyl group, such as methyl acrylate, ethyl acrylate, butyl acrylate, methyl methacrylate, ethyl methacrylate, and butyl methacrylate. An exemplary subbing resin is a terpolymer consisting of 80 wt % vinylidene chloride repeat units, 14 wt % acrylonitrile repeat units, and 6 wt % acrylic acid repeat units. Examples of preparation methods for such terpolymers are disclosed in U.S. Pat. No. 2,627,088, which is hereby incorporated by reference in its entirety.

The primer layers may, in some cases, further comprise at least one component that increases the adhesion between the primer layers and the transparent substrate. Such an adhesion promoter may, for example, be provided in an amount from about 0.1 wt % to about 5 wt % based on the weight of the one or more subbing resins. Non-limiting examples of suitable adhesion promoters include resorcinol, orcinol, catechol, pyrogallol, 1-naphthol, 2,4-dinitrophenol, 2,4,6-trinitrophenol, 4-chlororesorcinol, 2,4-dihydrotoluene, 1,3-naphthalenediol, 1,6-naphthalenediol, acrylic acid, the sodium salt of acrylic acid, 1-naphthol-4-sulfonic acid, benzyl alcohol, trichloroacetic acid, o-hydroxybenzotrifluoride, m-hydroxybenzotrifluoride, o-fluorophenol, m-fluorophenol, p-fluorophenol, chloro hydrate, and o-cresol. Such adhesion promoters may be used alone or in combination with other adhesion promoters.

The primer layers may, in some cases, further comprise solid materials, such as amorphous silica. When used, it may, for example, be provide in an amount from about 0.1 wt % to about 10 wt %, or from about 1 wt % to about 5 wt %, based on the weight of the one or more subbing resins. Other examples of suitable solid materials include glass, quartz, diatomaceous earth, and calcium carbonate. Without wishing to be bound by theory, it is believed that total light transmission may increase with increasing concentration of the solid materials in the primer layers.

The primer layers may, in some cases, further comprise dispersing or wetting agents. In some cases, such dispersing or wetting agents may, comprise anionic or non-ionic dispersing agents, such as, for example, sodium β,β[-(p-tert-octylphenoxy)ethoxy] ethane sulfonate, polyoxyethylene sorbitan monolaurate, polyoxyethylene sorbitan tristearate, polyoxyethylene sorbitan monooleate, and polyoxyethylene sorbitan trioleate. Saponin can also be used as a dispersing or wetting agent.

### Conductive Polymer Layers

At least some embodiments provide at least one conductive polymer layer disposed on the at least one first primer layer, the at least one second primer layer, or both. When conductive polymer layers are disposed on both primer layers, they may comprise the same composition or differing compositions, or the same thickness or differing thicknesses. Conductive polymer layers may, for example, have thicknesses from about 1 to about 30 μm, or from about 5 to about 15 μm, or from about 8 to about 12 μm, or about 10 μm.

In some embodiments that at least one first conductive polymer layer, or the at least one second conducive polymer layer, or both, may comprise one or more conductive polymers. Non-limiting examples of conductive polymers include substituted and unsubstituted polypyrrole, polyaniline, polyacetylene, substituted and unsubstituted polythiophenes, polyphenylene vinylene, polyphenylene sulfide, poly p-phenylene, and polyheterocycle vinylene. In some cases, conductive polymers comprising poly(3,4-ethylenedioxythiophene) doped with poly(styrenesulfonate) (PEDOT:PSS) may be used, as described in U.S. Pat. No. 5,300,575, which is hereby incorporated by reference in its entirety. PEDOT:PSS is commercially available as aqueous dispersions, such as CLEVIOS™ F EC 2 (Heraeus), CLEVIOS™ F 020 (Heraeus), CLEVIOS™ F EC 1 (Heraeus), CLEVIOS™ F ET (Heraeus), and ORACON™ S305 PLUS (Agfa).

### EXEMPLARY EMBODIMENTS

The following are 36 exemplary non-limiting embodiments:
A. A transparent conductive film comprising:
   a transparent substrate comprising a first surface and a second surface, the first surface and second surface disposed on opposite sides of the transparent substrate;
   at least one first primer layer disposed on the first surface of the transparent substrate, the at least one first primer layer comprising at least one first subbing resin and at least one first adhesion promoter; and
   at least one first conductive polymer layer disposed on the at least one primer layer, the at least one first conductive polymer layer comprising at least one first conductive polymer.
B. The transparent conductive film according to embodiment A, wherein the transparent substrate comprises at least one polyester.
C. The transparent conductive film according to either of embodiments A or B, wherein the transparent substrate comprises at least one polyester comprising at least about 70 wt % ethylene terephthalate repeat units.
D. The transparent conductive film according to any of embodiments A-C, wherein the transparent substrate comprises at least one polyester comprising at least about 95 wt % ethylene terephthalate repeat units.
E. The transparent conductive film according to any of embodiments A-D, wherein the transparent substrate comprises polyethylene terephthalate.
F. The transparent conductive film according to any of embodiments A-E, wherein the at least one first subbing resin comprises vinylidene chloride.
G. The transparent conductive film according to any of embodiments A-F, wherein the at least one first subbing resin comprises an ethylenically unsaturated ester.
H. The transparent conductive film according to any of embodiments A-G, wherein the at least one first subbing resin comprises at least one itaconic acid, the half methyl ester of itaconic acid, acrylic acid, or methacrylic acid.
J. The transparent conductive film according to any of embodiments A-H, wherein the at least one first subbing resin comprises from about 35 wt % to about 96 wt % of vinylidene chloride, from about 3.5 wt % to about 64.5 wt % of an ethylenically unsaturated ester, and from about 0.5 wt % to about 25 wt % of at least one of itaconic acid, the half methyl ester of itaconic acid, acrylic acid, or methacrylic acid.
K. The transparent conductive film according to any of embodiments A-J, wherein the at least one first subbing resin comprises a terpolymer of vinylidene chloride, acrylonitrile, and acrylic acid.
L. The transparent conductive film according to any of embodiments A-K, wherein the at least one first adhesion promoter comprises resorcinol.
M. The transparent conductive film according to any of embodiments A-L, wherein the at least one first adhesion promoter is present in amount from about 0.1 wt % to about 5 wt % based on the weight of the at least one first subbing resin.
N. The transparent conductive film according to any of embodiments A-M, wherein the at least one first primer layer has a thickness from about 0.05 μm to about 1 μm.
P. The transparent conductive film according to any of embodiments A-N, wherein the at least one first primer layer has a thickness from about 0.1 μm to about 0.2 μm.
Q. The transparent conductive film according to any of embodiments A-P, wherein the at least one first primer layer further comprises at least one first solid material comprising at least one of amorphous silica, glass, quartz, diatomaceous earth, or calcium carbonate.
R. The transparent conductive film according to any of embodiments A-P, wherein the at least one first primer layer further comprises at least one first solid material comprising amorphous silica.
S. The transparent conductive film according to either of embodiments Q or R, wherein the at least one first solid material is present in an amount from about 0.1 wt % to about 10 wt % based on the weight of the at least one first subbing resin.
T. The transparent conductive film according to either of embodiments Q or R, wherein the at least one first solid material is present in an amount from about 1 wt % to about 5 wt % based on the weight of the at least one first subbing resin.
U. The transparent conductive film according to any of embodiments A-T, wherein the at least one first conductive polymer comprises at least one of substituted or unsubstituted polypyrrole, polyaniline, polyacetylene, substituted or unsubstituted polythiophenes, polyphenylene vinylene, polyphenylene sulfide, poly p-phenylene, polyheterocycle vinylene, or poly(3,4-ethylenedioxythiophene) doped with poly(styrenesulfonate).
V. The transparent conductive film according to any of embodiments A-U, wherein the at least one first conductive polymer comprises poly(3,4-ethylenedioxythiophene) doped with poly(styrenesulfonate).
W. The transparent conductive film according to any of embodiments A-V, further comprising at least one second primer layer disposed on the second surface of the transparent substrate, the at least one second primer layer comprising at least one second subbing resin and at least one second adhesion promoter.
X. The transparent conductive film according to any of embodiment W, wherein the at least one second subbing resin comprises vinylidene chloride.
Y. The transparent conductive film according to either of embodiments W or X, wherein the at least one second subbing resin comprises an ethylenically unsaturated ester.
Z. The transparent conductive film according to any of embodiments W-Y, wherein the at least one second subbing resin comprises at least one itaconic acid, the half methyl ester of itaconic acid, acrylic acid, or methacrylic acid.
AA. The transparent conductive film according to any of embodiments W-Z, wherein the at least one second subbing resin comprises from about 35 wt % to about 96 wt % of vinylidene chloride, from about 3.5 wt % to about 64.5 wt % of an ethylenically unsaturated ester, and from about 0.5 wt % to about 25 wt % of at least one of itaconic acid, the half methyl ester of itaconic acid, acrylic acid, or methacrylic acid.
AB. The transparent conductive film according to any of embodiments W-AA, wherein the at least one second subbing resin comprises a terpolymer of vinylidene chloride, acrylonitrile, and acrylic acid.
AC. The transparent conductive film according to any of embodiments W-AB, wherein the at least one second adhesion promoter comprises resorcinol.
AD. The transparent conductive film according to any of embodiments W-AC, wherein the at least one second adhesion promoter is present in amount from about 0.1 wt % to about 5 wt % based on the weight of the at least one second subbing resin.
AE. The transparent conductive film according to any of embodiments W-AD, wherein the at least one second primer layer has a thickness from about 0.05 μm to about 1 μm.
AF. The transparent conductive film according to any of embodiments W-AE, wherein the at least one second primer layer has a thickness from about 0.1 μm to about 0.2 μm.
AG. The transparent conductive film according to any of embodiments W-AE, wherein the at least one second primer layer further comprises at least one second solid material comprising at least one of amorphous silica, glass, quartz, diatomaceous earth, or calcium carbonate.
AH. The transparent conductive film according to any of embodiments W-AE, wherein the at least one second primer layer further comprises at least one second solid material comprising amorphous silica.
AJ. The transparent conductive film according to either of embodiments AG or AH, wherein the at least one second solid material is present in an amount from about 0.1 wt % to about 10 wt % based on the weight of the at least one second subbing resin.
AK. The transparent conductive film according to either of embodiments AG or AH, wherein the at least one second solid material is present in an amount from about 1 wt % to about 5 wt % based on the weight of the at least one second subbing resin.
AL. The transparent conductive film according to any of embodiments W-AL, wherein the at least one second conductive polymer comprises at least one of substituted or unsubstituted polypyrrole, polyaniline, polyacetylene, substituted or unsubstituted polythiophenes, polyphenylene vinylene, polyphenylene sulfide, poly p-phenylene, polyheterocycle vinylene, or poly(3,4-ethylenedioxythiophene) doped with poly(styrenesulfonate).
AM. The transparent conductive film according to any of embodiments W-AL, wherein the at least one second conductive polymer comprises poly(3,4-ethylenedioxythiophene) doped with poly(styrenesulfonate).

### EXAMPLES

### Methods

Total light transmittance of films was measured according to the ASTM D-1003 test method using a BYK-Gardner HAZE-GARD PLUS hazemeter.

### Example 1

Several 7 mil polyethylene terephthalate (PET) substrates were evaluated for total light transmittance. These measurements averaged 91.70%.

### Example 2

An aqueous primer coating mixture was prepared, coated on one side of several 7 mil PET substrates, and then dried to form 0.169 g/m² primer coatings with thickness of about 0.1-0.2 μm. The resulting primer coatings consisted of 0.142 g/m² of a terpolymer of 80 parts by weight vinylidene chloride repeat units, 14 parts acrylonitrile repeat units, and 6 parts acrylic acid repeat units; 0.020 g/m² of resorcinol; 0.00532 g/m² amorphous silica; and 0.002 g/m² saponin. Total light transmittance of the coated PET substrates averaged 92.50%, which is higher than that of Example 1.

### Example 3

The aqueous primer coating mixture of Example 2 was coated on both sides of several 7 mil PET substrates, then dried to form 0.169 g/m² primer coatings with thickness of about 0.1-0.2 μm. Total light transmittance of the coated PET substrates averaged 94.30%, which is higher than those of Examples 1 and 2.

### Example 4

The PET substrates of Example 1 were each coated on one side with an aqueous dispersion of poly(3,4-ethylenedioxythiophene)-poly(styrenesulfonate) compounded polymer (CLEVIOS™ F EC 1, Heraeus), which was then dried to form 180 mg/m² (approximately 10 μm) coatings with 400 ohm/square nominal sheet resistance. Total light transmittance of the coated PET substrates averaged 89.3%.

### Example 5

The primer-coated PET substrates of Example 2 were each coated on the primer-coated side with an aqueous dispersion of poly(3,4-ethylenedioxythiophene)-poly(styrenesulfonate) compounded polymer (CLEVIOS™ F EC 1, Heraeus), which was then dried to form 180 mg/m² (approximately 10 μm) coatings with 400 ohm/square nominal sheet resistance. Total light transmittance of the coated PET substrates averaged 90.1%, which is higher than that of Example 4.

### Example 6

The primer-coated PET substrates of Example 3 were each coated on one of the primer-coated sides with an aqueous dispersion of poly(3,4-ethylenedioxythiophene)-poly(styrenesulfonate) compounded polymer (CLEVIOS™ F EC 1, Heraeus), which was then dried to form 180 mg/m² (approximately 10 μm) coatings with 400 ohm/square nominal sheet resistance. Total light transmittance of the coated PET substrates averaged 91.8%, which is higher than those of Examples 4 and 5.

### Example 7

The PET substrates of Example 1 were each coated on one side with an aqueous dispersion of poly(3,4-ethylenedioxythiophene)-poly(styrenesulfonate) compounded polymer (CLEVIOS™ F EC 2, Heraeus), which was then dried to form coatings of 284 mg/m² with 500 ohm/square nominal sheet resistance. Total light transmittance of the coated PET substrates averaged 85.2%.

### Example 8

The primer-coated PET substrates of Example 2 were each coated on the primer-coated side with an aqueous dispersion of poly(3,4-ethylenedioxythiophene)-poly(styrenesulfonate) compounded polymer (CLEVIOS™ F EC 2, Heraeus), which was then dried to form coatings of 284 mg/m² with 500 ohm/square nominal sheet resistance. Total light transmittance of the coated PET substrates averaged 86.7%, which is higher than that of Example 7.

### Example 9

The primer-coated PET substrates of Example 3 were each coated on one of the primer-coated sides with an aqueous dispersion of poly(3,4-ethylenedioxythiophene)-poly(styrenesulfonate) compounded polymer (CLEVIOS™ F EC 2, Heraeus), which was then dried to form coatings of 284 mg/m² with 500 ohm/square nominal sheet resistance. Total light transmittance of the coated PET substrates averaged 88.3%, which is higher than those of Examples 7 and 8.

The invention has been described in detail with reference to particular embodiments, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A transparent conductive film comprising:
a transparent substrate comprising a first surface and a second surface, the first surface and second surface disposed on opposite sides of the transparent substrate;
at least one first primer layer disposed on the first surface of the transparent substrate, the at least one first primer layer comprising at least one first subbing resin and at least one first adhesion promoter; and
at least one first conductive polymer layer disposed on the at least one first primer layer, the at least one first conductive polymer layer comprising at least one first conductive polymer.

2. The transparent conductive film according to claim 1, wherein the at least one first subbing resin comprises from about 35 wt % to about 96 wt % of vinylidene chloride, from about 3.5 wt % to about 64.5 wt % of an ethylenically unsaturated ester, and from about 0.5 wt % to about 25 wt % of at least one of itaconic acid, the half methyl ester of itaconic acid, acrylic acid, or methacrylic acid.

3. The transparent conductive film according to claim 1, wherein the at least one first subbing resin comprises a terpolymer of vinylidene chloride, acrylonitrile, and acrylic acid.

4. The transparent conductive film according to claim 1, wherein the at least one first adhesion promoter comprises resorcinol.

5. The transparent conductive film according to claim 1, wherein the at least one first primer layer further comprises at least one first solid material comprising at least one of amorphous silica, glass, quartz, diatomaceous earth, or calcium carbonate.

6. The transparent conductive film according to claim 1, wherein the at least one first primer layer further comprises at least one first solid material comprising amorphous silica.

7. The transparent conductive film according to claim 1, wherein the at least one first conductive polymer comprises poly(3,4-ethylenedioxythiophene) doped with poly(styrenesulfonate).

8. The transparent conductive film according to claim 1, further comprising at least one second primer layer disposed on the second surface of the transparent substrate, the at least one second primer layer comprising at least one second subbing resin and at least one second adhesion promoter.

9. The transparent conductive film according to claim 8, further comprising at least one second conductive polymer layer disposed on the at least one second primer layer, the at least one second conductive polymer layer comprising at least one second conductive polymer.

10. The transparent conductive film according to claim 9, wherein the at least one second conductive polymer comprises poly(3,4-ethylenedioxythiophene) doped with poly(styrenesulfonate).
